(19) United States
(12) Patent Application Publication
(10) Pub. No.: US 2017/0081880 A1
(43) Pub. Date: Mar. 23, 2017

(54) BLANK KEY, A LOCK SET WITH A SECURITY MECHANISM AND METHOD FOR PRODUCING SAME

(71) Applicant: Raphael Moshe Inbar, Eilat (IL)

(72) Inventor: Eyal ARTSIELY, Moshav Yafit (IL)

(21) Appl. No.: 14/859,388

(22) Filed: Sep. 21, 2015

(51) Int. Cl. E05B 27/00; E05B 35/00; E05B 19/00

(52) U.S. Cl. CPC E05B 27/0082; E05B 19/0017; E05B 19/0023; E05B 19/0064; E05B 35/003; E05B 27/0014; E05B 27/0021

(57) ABSTRACT

A lock set comprising a cylinder lock having a stator and a rotatable member rotatable in the stator and having a key slot and at least one side; a security element with protrusions, pivotally connected to the rotatable member; and one or more fitting keys, each having one or more recesses and one or more extensible members. The distances between the protrusions of the security element correspond to locations of the recess(es) and extendible member(s) of the fitting key for engagement therewith, such that using the fitting key will have the security element positioned in a non-obstructing position allowing free rotation of the rotatable member in the stator and using an unfitting key will cause a portion of the security element to protrude from the outer wall of the rotatable member engaging the inner wall of the stator thereby preventing rotation of the rotatable member in the stator.

### FIELD OF THE INVENTION

The present invention generally relates to keys, locking devices, apparatuses, sets and mechanisms and more particularly to key blanks, keys and lock sets having a security mechanism embedded therein and methods for producing thereof.

### BACKGROUND OF THE INVENTION

Cylinder locks typically include a stator configured for being installed in the system it is to secure such as a door or a car starter system and the like, and a rotor member having a key slot therein for receiving a key fitted to the particular cylinder lock for locking and unlocking thereof.

The rotor component of the cylinder lock in many designs has one or more pins moveable by springs that are adapted to fit key cuts indented over one or more surfaces of the key for pressing them towards the inner wall of the stator for enabling the rotation of the rotor inside the stator usually for moving one or more cam tenons thereof for releasing or projecting an engaging member of the lock set for locking or unlocking e.g. a door.

Patent application no. EP2108767 to Alban teaches a cylinder lock comprising: a stator, a cylindrical rotor for the actuation of the bolt, which is accommodated rotatably within the stator and in which a slot for the opening of a key for the operation of the lock is formed, coding pins and driver pins for blocking the rotation of the rotor within the stator, which can slide within radial holes provided correspondingly within the rotor and within the stator, elastic means for pushing the coding pins against an internal wall of the slot, which faces the holes, the elastic means being further adapted to align the coding pins and the driver pins to allow the rotation of the rotor within the stator when one key having a predefined profile for opening the lock is inserted in the slot; at least one pusher, which is accommodated in at least one first hole of the holes and defines a safety position for at least one first pin of the coding pins in which the first coding pin is spaced from the wall even when no key is inserted in the slot.

U.S. Pat. No. 5,520,035 to Eizen et al. teaches a key blank including a generally elongate shaft portion defining a key combination surface adapted to have formed thereon key cuts which define a key combination, the key blank including a movable pin element retained within the elongate shaft portion, the movable pin element being displaceable in a single direction, outwardly from the key combination surface.

### SUMMARY OF THE INVENTION

The present invention, in some aspects thereof, provides a lock set comprising: (a) cylinder lock having a stator and a rotatable member configured for being coaxially situated in said stator for rotating therein, the rotatable member having at least one key slot for receiving the key therein and at least one side slot; (b) at least one security element having at least two protrusions, each security element being configured to fit into one of the one or more side slots of the rotatable member and pivotally connects to the rotatable member; and (c) at least one fitting key with an elongated key member having at least one recess disposed over at least one side thereof and at least one extensible member inserted inside the elongated key member and protruding from at least one side thereof. The extendible member is configured to move along a predefined axis from which it protrudes. Each key recess is located and configured such as to fit in engagement to a security element's protrusion such that when the fitting key is inserted through the key slot of the rotatable member the protrusions of the security element engage the at least one extendible member and the at least one recess of the fitting key such that the security element is positioned in a non-obstructing position, in which no portion thereof protrudes from an outer wall of the rotatable member allowing thereby rotation of the rotational member in the stator. Using an unfitting key by inserting thereof into the key slot will cause the security element to reach or maintain it in a obstructing position, in which at least a portion of the security element protrudes from the outer wall of the rotatable member engaging the inner wall of the stator thereby preventing the rotatable member from rotating in the stator.

The lock set optionally further comprises a buffering element such as a spring, located and configured such as to engage the security element in the cylinder lock such as to maintain it in the obstructing position when no key is inserted through the key slot, such that a fitting key will counterpoise the buffering element(s) and thereby rotate the security element about its axis for bringing it to the non-obstructing position.

According to some embodiments, each buffering element is located offset from the rotational axis of the security member opposite to the side in which the at least one extendible member of the key is to be positioned when the key is inserted into the cylinder lock.

According to some embodiments, the stator comprises a cylindrical body having at least one stator groove slotted over its inner wall located generally opposite and in parallel to the side slot of the rotatable member, wherein in the obstructing position, at least a portion of at least one security element of the lock set protrudes from the outer wall of the rotatable member and is inserted into the groove.

According to some embodiments, a side wall of the side slot of the rotatable member in which the security element is seated has indentations fitted in shape and size for receiving therein the protrusions of the security element.

According to some embodiments, the lock set further comprises an additional locking mechanism comprising a set of pins or extendible pins located in the rotatable member of the cylinder lock for locking and unlocking upon engagement with respective indentations over at least one side of each fitting key.

According to some embodiments, each extendible member in the fitting key comprises two pins engaging a spring located therebetween, wherein each pin can protrude from each side of a designated opening inside the key or only one pin can protrude from one side thereof.

According to some embodiments, the lock set is designed as a door lock or as a vehicle starter or vehicle door lock.

According to some embodiments, the stator of the cylinder lock comprises a rotatable cam having at least one tenons thereover.

According to some embodiments, the rotatable member comprises at least one hole for threading a hinge therethrough for pivotally connecting the security element to an inner wall of the rotatable member formed by the side slot thereof.

According to some embodiments, the rotatable member comprises multiple holes for determining the location of the hinge and thereby the location of the security element in the side slot according to the security element size being used.

According to some embodiments, the cylinder lock further comprises at least one buffering element and the security element comprises at least one indentation or protrusion located such as to engage the at least one buffering element.

According to some embodiments, the lock set comprises multiple security elements each fitting at least one recess located at different sides of each fitting key.

The present invention, according to other aspects thereof, provides a method for producing lock sets comprising: (a) providing multiple stators for cylinder locks of a specific cylinder lock design all being substantially identical in size and shape; (b) providing multiple identical rotatable members for the cylinder locks design configured to coaxially fit to said stators such as to rotate therein about a rotation axis, each rotatable member having a key slot therein for receiving a key and at least one side slot; (c) providing multiple blank keys each having an elongated key member; (d) producing multiple security elements each group thereof having a different design each having at least two protrusions; (e) providing multiple extendible members configured for moving along an axis thereof; and (f) forming a unique lock set by: (i) selecting a single rotatable member and stator; (ii) selecting at least one specific security element and at least one key blank for forming at least one fitting key of the specific lock set therefrom; (iii) pivotally connecting each of the selected at least one security element to the rotatable member via the side slot thereof; (iv) inserting at least one extendible member to its at least one designated opening in each key blank selected for the lock set; (v) forming at least one recess and at least one hole over at least one side of each key member of each selected key blank at predefined possible locations over each key member for each specific lock set to be produced according to the design of its corresponding selected at least one security element it is to fit; and (vi) inserting at least one extendible member into the at least one opening in each key member of each selected key blank for specifying the key blank turning thereof into a fitting key to the specific key set. Each recess formed in each key of each particular lock set is located and configured such as to fit in engagement at least one of the security element's protrusions such that when a fitting key is inserted through the key slot of the rotatable member the protrusions of the security element engage the at least one extendible member and the at least one recess of the inserted fitting key such that the security element is positioned in a non-obstructing position, in which no portion thereof protrudes from an outer wall of the rotatable member allowing thereby rotation of the rotational member in the stator of the lock set. When an unfitting key is inserted into the key slot the security element will reach or maintain an obstructing position, in which the at least a portion of the security element protrudes from the outer wall of the rotatable member engaging the inner wall of the stator thereby preventing the rotatable member from rotating in the stator.

According to some embodiments, each stator has a cylindrical body having an opening for receiving a rotatable member therein and at least one stator groove slotted over its inner wall located opposite and in parallel to the side slot of the rotatable member when the rotatable member is inserted therein, said groove is configured for receiving therein a portion of said security element to form the obstructing position.

The method optionally further comprises forming multiple holes over each security element for allowing determining a location of a hinge and thereby the location of the security element in said side slot according to the security element size being used for the particular lock set.

The method additionally or alternatively further comprises adding an additional locking mechanism to the cylinder lock to increase the number of possible combinations of unique lock sets. The adding of the additional locking mechanism optionally involves adding multiple extendible pins penetrated through openings in each said rotatable member and indenting at least one side of each key with indentations that correspond to the locations and lengths of the extendible pins of the particular cylinder lock.

According to some embodiments, the method further comprises fixing at least one buffering element in the cylinder lock located and configured such as to maintain the security element in the rotatable member in ab obstructing position until a counterpoised force is applied thereto by a fitting key inserted through the key slot of the particular rotatable member.

The method optionally further comprises slotting at least one groove over an inner wall of each stator for receiving therein the portion of the security element when the security element protrudes from the outer wall of the rotatable member, wherein the location and design of each groove fits the location and design of the security element when located in the rotatable member.

The present invention, according to yet other aspects thereof, provides a key blank for forming therewith a fitting key to a cylinder lock, wherein the key blank comprises: an elongated key member having at least one opening over at least one side thereof; and at least one extendible member each inserted in each of the at least one opening in the elongated key member, wherein at least one side of the extendible member protrudes from the opening and is extendible along an axis of its protrusion in response applied thereover. The key blank is configured for producing therewith a key for a specific cylinder lock by forming at least one recess over at least one side thereof, each recesses is formed for receiving therein a protrusion of a security element of the cylinder lock, such that the location and depth of each recesses is adapted to the location and the length of the protrusion it is to receive therein. Each extendible member of the fitting key, formed from the key blank, engages a respective protrusion of the security element and each recess of the fitting key receives therein another protrusion of the security element fitting thereto such as to have the security element positioned in a non-obstructing position, when the fitting key is inserted in the cylinder lock, in which a rotatable member of the cylinder lock can freely rotate in a stator thereof by having the security element reach a position in which it does not protrude from outer wall of the rotatable member.

The present invention also provides a method for forming a fitting key using a key blank, according to some aspects of the invention, for fitting to a specific cylinder lock, this method comprises: (a) providing a specific cylinder lock having a stator, a rotatable member configured for rotating in the stator, wherein the rotatable member has a key slot and at least one side slot, and a security element having protrusions pivotally connected in the rotatable member via its side slot; (b) providing a blank key having an elongated key member with at least one opening over at least one side thereof and at least one extendible member each inserted in each of the at least one opening in the elongated key member; (c) forming at least one recess over at least one side of the elongated key member of the key blank for forming a fitting key to the specific cylinder lock. At least one side of each extendible member protrudes from the opening thereof and is extendible along an axis of its protrusion in response applied thereover. Each recesses of the key blank is formed for receiving therein a protrusion of the security element of the specific cylinder lock, such that the location and depth of each recesses is adapted to the location and the length of the protrusion it is to receive therein, wherein, when the fitting key formed from the key blank is inserted through the key slot, each extendible member of the fitting key engages a respective protrusion of the security element and each recess of the fitting key receives therein another protrusion of the security element fitting thereto such as to have the security element positioned in a non-obstructing position, in which the rotatable member can freely rotate in the stator by having the security element reach a position in which it does not protrude from outer wall of the rotatable member.

### BRIEF DESCRIPTION OF THE DRAWINGS

FIG. 1 shows an exploded view of a lock set having a security mechanism, according to some embodiments of the present invention.

FIG. 2 shows a key fitting to the lock set of FIG. 1, according to some embodiments of the present invention.

FIG. 3 shows a cross sectional view of a rotatable member of a cylinder lock of the lock set shown in FIG. 1.

FIG. 4 shows a frontal view of a stator of the lock set as described in FIG. 1 showing a groove slotted over an inner side thereof that corresponds in size, shape and location a side slot of the rotatable member for having the security element of the lock set protrude into this groove for preventing rotation of the rotatable member in the stator, according to some embodiments of the invention.

FIG. 5 shows an exploded view of a lock set with a security mechanism of a different size than that illustrated in FIG. 1, according to some embodiments of the present invention.

FIGS. 6A-6C show cross sectional views of three different lock sets having security elements of a specific first type having the same overall length, according to some embodiments of the present invention, differentiated from one another by the lengths of one or two protrusions of their security element requiring different key recess and/or forming different operating positions of the extendible member: FIG. 6A shows a lock set having a security element in which the first protrusion is longer than the second protrusion; FIG. 6B shows a lock set having a security element in which the first protrusion is longer than the second protrusion; and FIG. 6C shows a lock set having a security element having protrusions of the same length.

FIGS. 7A-7C show cross sectional views of three different lock sets having a security element of a specific second type having the same overall length, which is shorter than the length of the first type security elements, according to some embodiments of the present invention differentiated from one another by the length of protrusions of their security elements requiring different key recess and/or extendible member sizes: FIG. 7A shows a lock set having a security element in which the first protrusion is longer than the second protrusion; FIG. 7B shows a lock set having a security element in which the first protrusion is longer than the second protrusion; and FIG. 7C shows a lock set having a security element having protrusions of the same length.

FIGS. 8A, 8B and 8C show different security elements of the first type having the same overall height and varied protrusions lengths and varied inner indentations sizes and/or locations.

FIGS. 9A, 9B and 9C show different security elements of the second type having the same overall height, which is shorter than that of the first type.

FIGS. 10A-10C show how different keys being inserted into the same cylinder lock, wherein only one of the keys fits the specific lock by having fitting indentations and fitting length of extendible member and recess depth and the other keys are unfitting keys: FIG. 10A shows the lock set with the fitting key having the security element thereof in anon-obstructing position allowing the rotatable member to freely rotate in the stator of the lock set; FIG. 10B shows the cylinder lock and security element thereof having an unfitting key placed in the slot of the rotatable member of the cylinder lock, causing the security element to protrude from the outer wall of the rotatable member into the stator slot preventing thereby rotation of the rotatable member inside the stator; and FIG. 10C shows the cylinder lock and security element thereof having an unfitting key placed in the slot of the rotatable member of the cylinder lock, causing the security element to protrude from the outer wall of the rotatable member at another side thereof, also preventing thereby rotation of the rotatable member inside the stator of the cylinder lock.

FIGS. 11A and 11B show a lock set having cylinder lock and a key such as a blank master key or an indented key, according to other embodiments of the invention: FIG. 11A shows an exploded view of the lock set with the key; and FIG. 11B shows a perspective view of the secured lock set with the key inserted inside the cylinder lock.

FIGS. 12A and 12B show a lock set having a KIK (key in knob) cylinder lock, according to yet other embodiments of the invention: FIG. 12A shows an exploded view of the lock set with a key blank and FIG. 12B shows a perspective view of the secured lock set with a key blank inserted inside the cylinder lock.

FIGS. 13A and 13B show a lock set having cylinder lock, according to other embodiments of the invention: FIG. 13A shows an exploded view of the secured lock set with a key blank; and FIG. 13B shows a perspective view of the secured lock set with the key blank inserted inside the secured cylinder lock.

FIGS. 14A and 14B show a key blank, according to some embodiments of the present invention, having an extendible member inserted through a designated opening over a side thereof for adapting thereof to a specific lock set cylinder lock having a security element with two or more protrusions by forming one or more recesses over the same or another side thereof in locations and properties such as depth and size that correspond to the protrusions of the security element they are to receive therein: FIG. 14A shows an elevated view of the key blank; and FIG. 14B shows a perspective view of the key blank.

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention provides key blanks, lock sets with cylinder locks and method of producing thereof, where the lock sets have auxiliary security mechanisms embedded therein for enhancing one or more locking and unlocking mechanisms of the cylinder locks thereof for improved safety and easy manufacturing, assembling and dismantling.

Each lock set has a stator and a rotatable member coaxially arranged for having the rotatable member rotating in the stator for locking and unlocking, and at least one security element placed inside a side slot in the rotatable member and pivotally connected to that member such that in order to prevent rotation of the rotatable member inside the stator (for locking or unlocking) when a non-fitting key is used for instance and optionally when no key is inserted through the rotatable member's key slot, at least a portion of the security element protrudes from the outer wall of the rotatable member towards the stator. The cylinder lock also may have one or more other standard locking mechanisms referred to herein as the additional locking mechanism(s) of the cylinder lock, such as the standard one or more sets of extendible pins enabling to lock and unlock by fitting into specific key indentations.

The security element pivotally connects to a wall cut formed by the side slot of the rotatable member via a hinge for instance. This side slot may be parallel to the axis of rotation of the rotatable member.

According to some embodiments, the stator has at least one groove in its inner wall that corresponds in length and location at least to the position and length of the security element such that when an unfitting key is used, the security element will rotate about an axis thereof and portion thereof will protrude from the outer wall of the rotatable member and be inserted into the stator groove preventing thereby the rotatable member from rotating inside the stator. When a fitting is used, the security element will reach a non-obstructing position, in which its outer side does not penetrate the slot groove for allowing the rotatable member to rotate in the stator. This position is achieved by causing the security element to rotate about its axis for instance.

According to some embodiments, the security element has an elongated shape having two or more protrusions.

According to some embodiments, the key of each lock set includes an elongated key member at least one recess disposed over a side of said elongated key member and at least one extensible member inserted inside the elongated key member and protruding from a side thereof. The extendible pin is designed to apply force over a protrusion of the security element engaging thereof, for causing the security element to rotate slightly about its axis for allowing one or more other protrusions thereof that do not engage the extendible pin to be inserted into their respective one or more recesses in the key. If an unfitting key is used having a recess or more which depth does not fit to receive the protrusion of the security element the security element maintain rotated such that a portion thereof will protrude from the rotatable member inside the stator groove obstructing thereby the rotation of the rotatable member in the stator.

Each recess over the side of the key is configured for receiving therein a protrusion of the security element such that the distance(s) between the protrusions of the security element exactly fit the distance between the key recess(es) and the extendible member(s) locations and the depth of the at least one recess and the length of the extendible member(s) when in a relaxed state fit, respectively, their corresponding security element's protrusions they are to engage.

According to some embodiments, an inner buffering means is used to maintain the security element in a “obstructing position” in which portion thereof protrudes into the stator groove to maintain this groove in the right alignment in respect to the side slot of the rotatable member preventing the rotatable member from rotating in the stator. The buffering means may include one or more springs located offset from the rotation axis of the security element engaging the security element such as to push a portion thereof towards the stator groove.

When a fitting key is inserted through the key slot, the security element will be rotated back from its original position inside the rotatable member becoming coplanar with the slot groove for allowing the rotatable member to rotate in the stator for locking or unlocking therewith. However, in a relaxed state or when an unfitting key will be inserted, even if the indentations on the upper or lower surfaces are identical to the fitting key in size, shape locations depths and height etc., the security element is slightly rotated about its fixation axis thereby have on either side thereof protrude from the outer wall of the rotatable member towards the stator groove for preventing rotation of the rotatable member thereby.

The security element's length, which determines the distance between its edge protrusions, is configured to fit the locations of the at least one extendible member and the at least one recess of the one or more fitting keys of the lock set such that the distance between the recess and extendible member is equal to the distance between the protrusions of the security element. The inner side wall of the rotatable member in which the security element is seated should also include indentations (recesses) for receiving therein the protrusions of the security element.

According to some embodiment each cylinder lock can have multiple security elements whereas a fitting key should have correspondently one or more extendible members and recesses fitting the protrusions of all security elements of the lock set.

According to some embodiments, the additional locking mechanism of the cylinder lock includes a set of extendible pins such as telescopic pins located in the stator and protruding from holes in the rotatable member of the cylinder lock for locking and unlocking upon engagement with respective indentations in a fitting key.

Producing each of the one or more fitting keys for each lock set may include for instance, using a blank key having one or more holes for receiving the one or more extendible members therein and one or more recesses over one or more sides thereof. The fitting of the key (e.g. by a locksmith) to the specific lock set i.e. to the specific design and location of its one or more security elements, is done by placing the one or more extendible members into the designated hole(S) thereof over the blank key and forming one or more recess thereover that correspond to the location(s) of the protrusion(s) of the security element(s) each recess is to engage. The one or more recesses of each key of each particular design of a lock set may be formed by using simple available tools, where the size, location, depth and shape of each recess is determined according to the properties of its matching security element protrusion.

The blank key may be marketed with one or more standard one sized extendible members already placed in their holes such that specifying of each key to its corresponding lock set will simply require indenting the one or more recesses thereover. In these cases, one or more designs of key blanks may be available each having one or more extendible members in the key blanks.

The fitting keys production out of the blank keys for fitting to their respective lock sets and their special security element's design, may additionally include indenting the key blanks after or before the forming of their recesses to fit to an additional locking mechanism of the lock set.

The lock sets of the present invention can be used for any kind of lock such as a door lock or as a vehicle starter lock and the like for actuating a bolt, closing an electric circuit or any actuation a cylinder lock is used for. For example, the cylinder lock is a mortise or bored lock having a gear cam having one or more protruding elements for ultimately pulling or pushing a latch bolt of a latch assembly installed in the door. In other cases the rotation of the rotational member closes an electric circuit for starting a vehicle or even switching on or off any other device or machine.

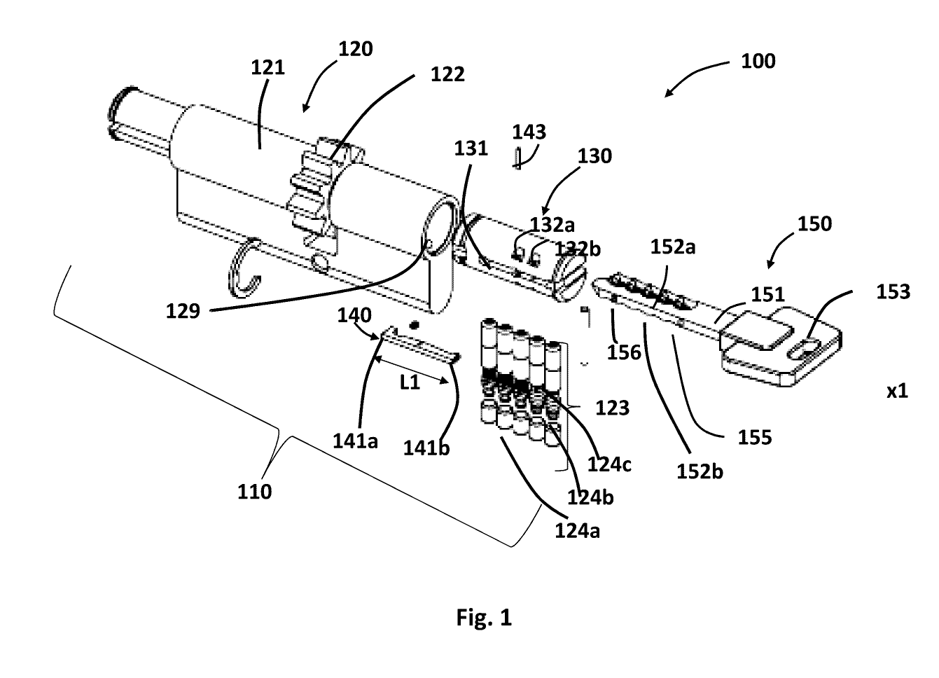

Reference is now made to FIGS. 1-4, which show a lock set 100, according to some embodiments of the present invention, or parts thereof.

The lock set 100 includes: a cylinder lock assembly 110 comprising a stator 120 having an inner stator groove 129, a rotatable member 130 having a key slot 131a and a side slot 131b and a security element 140; and one or more key such as key 150 configured for fitting thereto at least for fitting to the security element 140 such as to allow the security element 140 to be positioned in a non-obstructing position, when the key 150 is inserted to the key slot of the rotatable member. The non-obstructing position is defined herein as a position in which the security element 140 or any portion thereof does not protrude from the outer wall of the rotatable member 130 through its side slot 131b and therefore no part thereof is inserted into the stator groove 129 allowing thereby the rotatable member 130 to rotate in the stator 120. In the non-obstructing position of the security element 140 its outer side is parallel to the rotation axis “x1” of the rotatable member 130 and is either surfaced with its outer wall or slightly sunken in the side slot 13b1 thereof.

As shown in FIG. 1, the stator 120 has the groove 129, a cylindrical body 121 and a gear cam 122 as well as a set of extendible pins 123 having multiple telescopic pins 124c each engaging a spring 124b connected to a pin base 124a thereof. The key 150 includes a key head 153, an elongated key member 151 having upper and lower indentations 152a and 152b, respectively for moving the pins 124c of the stator 120 for locking and unlocking the additional locking mechanism thereof.

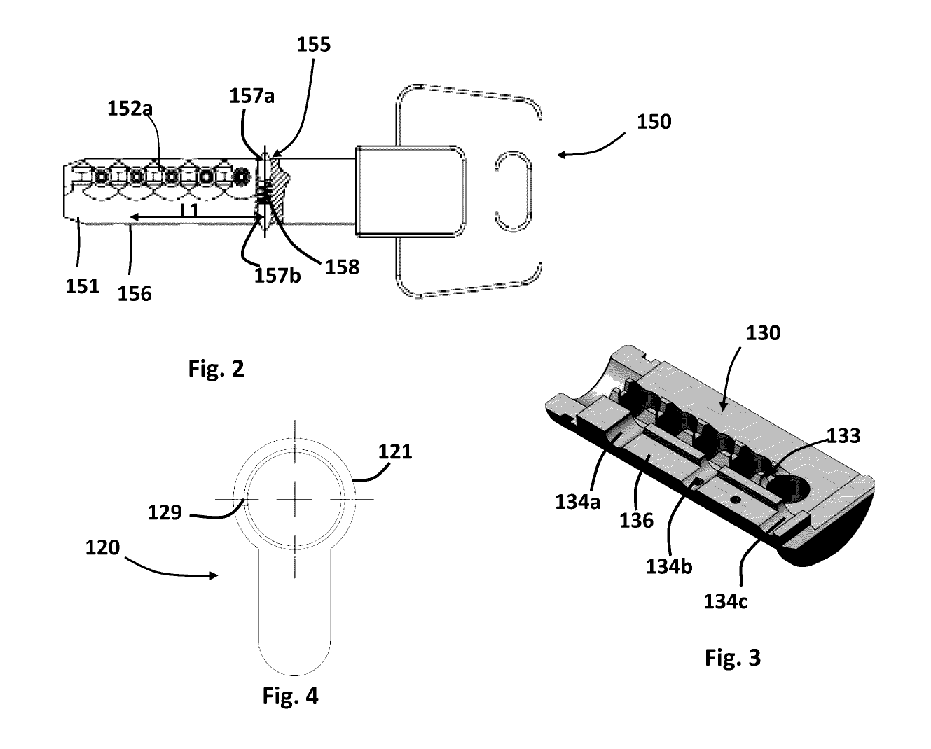

The key 150 also includes a coded recess 156 and an extendible member 155 located at a side thereof that is not indented distant from one another in a distance L1 that corresponds to the distance L1 between the edges 141a-241b of the security element 140. FIG. 2 shows details of the extendible member 155 of the key 150 allowing it to change in length by compressing or decompressing a spring 158 thereof in response to forces applied thereover in the direction (axis) of protrusion thereof. The spring 158 connects to pins 157a and 157b at edges thereof.

As shown in FIG. 1 and FIG. 3, the rotatable member 130 includes the key slot 131a designed for receiving the key 150 therein from one side thereof and the side slot 131b, which in this case is separated therefrom for placing the security element 140 therethrough. This side slot 131b forms a side wall 136 over the rotatable member 130 to which the security element 140 is pivotally connected via a hinge 143 wherein protrusions 141a-141b of this security element 140 will be positioned within recesses (indentations) 134a-134c of that rotatable member 130 side wall 136.

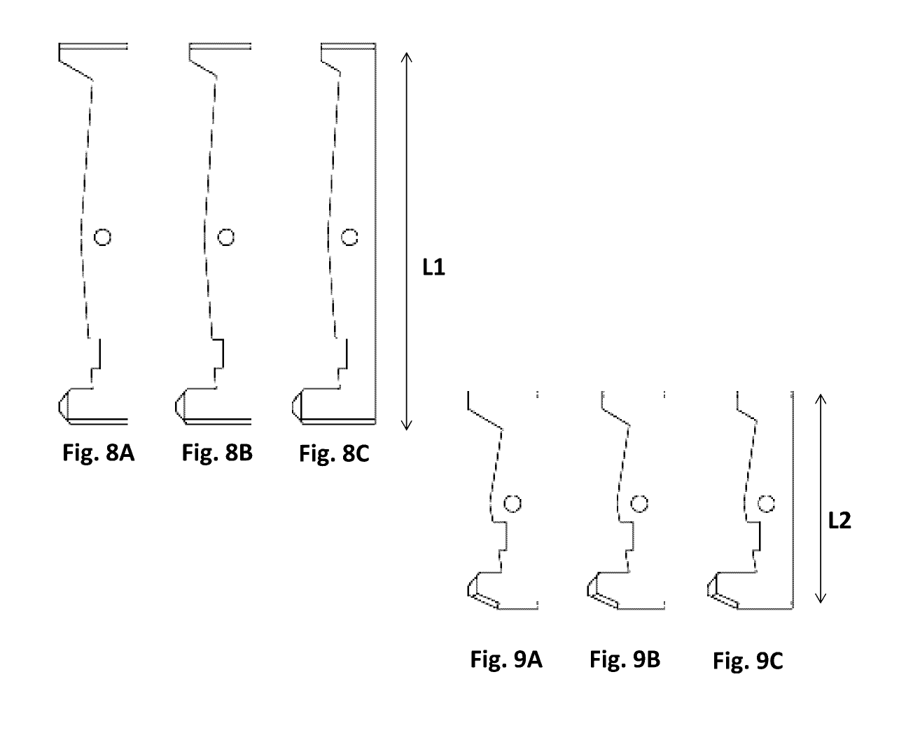

As illustrated in FIG. 3, the side wall 136 includes three recesses 134a-134c for manufacturing the same rotatable member 130 that will fit at least two types of security elements each having a different overall length “L1’ or “L2” (see FIGS. 8A-9C). Each type of security element can have the same length but vary in the size and optionally also the number of its protrusions for uniquely fit only the keys having the corresponding extendible member(s) and recess(es).

In this way the same stator and the same rotatable member can be mass produced changing only the type and shape of the security element for uniquely defining the keys that can be used for locking and unlocking the specific lock set therewith.

As shown in FIG. 3, the rotatable member 130 also includes openings 133 for receiving therethrough the extendible pins 123 of the additional locking mechanism of the cylinder lock 110.

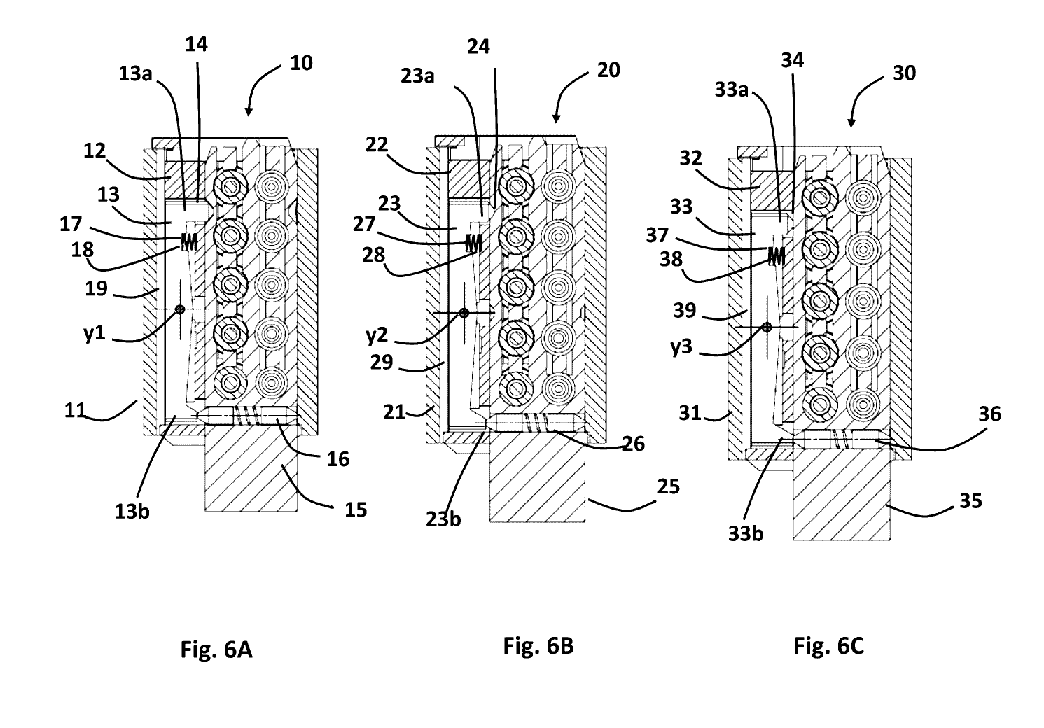

As shown in FIG. 1, the rotatable member 130 is coaxially positioned in the stator 120 defining a rotation axis x1 thereof. When no key is inserted through the key slot 131a, the security element 140 should be maintained such that a portion of its outer wall is inserted through the stator groove 129 unless a fitting key is placed retracting the security element by rotating thereof about its axis such that it will not protrude from the outer walls of the rotatable member 130 for allowing it to rotate in the stator 120. To maintain the security element 140 protruding into the stator groove 129 one or more buffering means (not shown) can be used as will be illustrated in FIGS. 6A-6C.

According to some embodiments, the rotatable member 133 also includes two holes 132a and 132b for allowing inserting the security element hinge 147 through any of them depending on the desired location of the hinge 147 (hole 132a for the shorter security element and hole 132b for the longer one).

According to other embodiments, the security element 140 is maintained in a non-obstructing position also when no key is inserted through the key slot, in which cases the opening of an unfitting key will actively cause the rotation of the security element for bringing it to the obstructing position thereof.

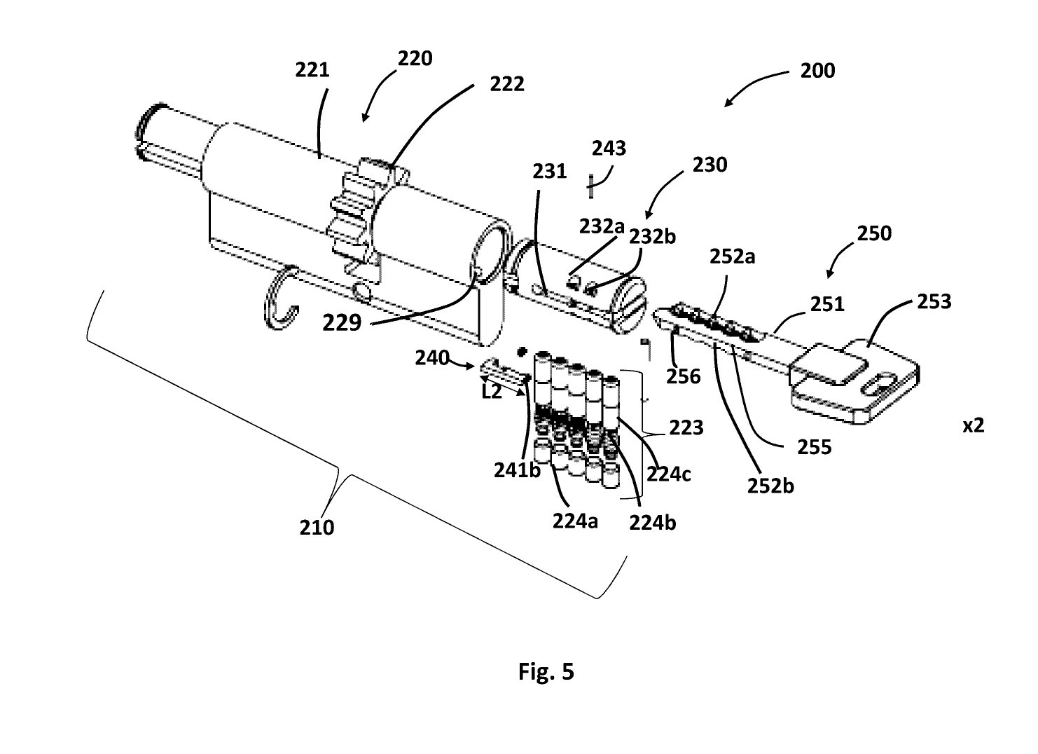

FIG. 5 shows an exploded view of a lock set 200 having a similar cylinder lock 210 design as cylinder lock 110 using a different length type of security element 240, which is shorter than the security element 140, according to some embodiments of the present invention. The components of the cylinder lock 210 of: a stator 220 having a cylindrical body 221 with an inner groove 229, a gear cam 222, and an extendible pins set 223 are similar in location, design and sizes to their corresponding components 120, 129, 121, 122, and 123 of cylinder lock 110. The locations of the holes 232a-232b are also in the same positions as in 132a-132b, respectively as well as the shape size and location of the side slot 231 for allowing selecting where to insert the security element hinge 243 from. However, the use of a security element 240 of a different length L2 having its protrusions 241a-241b located at a different distance from each other than the distance between the edges 141a-141b of the security element 140, will require using a key 250 having its extendible member 255 and recess 256 located at a distance from one another that corresponds to the length L2 of the security element 240.

The key 250 also includes a key head 253, an elongated key member 251 having upper and lower indentations 252a-252b corresponding to the extendible pins 223 each including a pin head 224c connected to a base 224a via a spring 224b.

For reducing manufacturing costs and resources, each key may be configured out of a generic blank key forming one or more holes at a predefined location(s) thereover, for receiving the one or more extendible member(s) therein and on or more recesses of varied depths and optionally varied shapes for allowing specifying the key to the unique lock by inserting a different length extendible member into the designated hole, optionally also forming recesses of different depths for each lock set, and by forming the unique indentation pattern of the specific key to fit the cylinder lock specific extendible pins set.

The security mechanism, including the security element placed in the designated slot thereof and the extendible member(s) and recess(es) in the key may be used as a single locking mechanism of the lock set or added as an auxiliary locking mechanism to one or more additional locking mechanisms that will also increase the number of possible combinations for each lock set design using only two or more limited number of different security element sizes and designs to form unique combinations.

In this case the first stage of mass production of lock sets eventually forming a unique locking specifications therefore, will be to form multiple duplicate stators of the same shape and size (including their cam or any other latching mechanism) and multiple duplicate rotatable members and providing multiple blank keys and then forming the hole(s) and recess(es) thereover; then a set of two types of security elements may be manufactured having the edges of each element being cut at a unique manner for specifying thereof to a single lock set.

In some embodiments the production also includes mass producing extendible members of the same length shape and size with coiled springs of the same properties or of varied sizes and properties selected form a limited number of optional designs to fit various lock sets.

Optionally, if the lock set uses one or more additional locking mechanisms the production also involves specifying each lock set by selecting a different set of extendible pins and indenting the sides of the keys thereof correspondently. In this way the key has to fit to both the security element length, edges distances and lengths (and optionally unique shape) as well as to the extendible pins of the cylinder lock for enabling using thereof.

Since there are many components of different nature that have to fit to one another, unauthorized duplication of such keys will be nearly impossible as well as using a master key.

Any number of security elements lengths can be used depending on manufacturing costs and other considerations as well as any design thereof (i.e. number of protruding edges thereof and shape of each edge etc.).

Any number of designs of extendible members can also be used such as a single unified design for reducing production costs or multiple designs.

Any type of known in the art locking mechanism can be used for the additional locking mechanism if such is used and not necessarily or solely the extendible pins locking principle.

FIGS. 6A-6C show cross sectional views of three different lock sets 10, 20 and 30 having a security element 13, 23 and 33 of a specific first type having the same overall length L1, differentiated from one another by the length of protrusions of their security elements requiring different key recess and/or extendible member sizes for each: FIG. 6A shows a lock set having a security element in which the first protrusion 13a is longer than the second protrusion 13b; FIG. 6B shows a lock set having a security element in which the first protrusion 23a is longer than the second protrusion 23b; and FIG. 6C shows a lock set having a security element in which both protrusion 33a and 33b are of the same length. Each lock set 10, 20 and 30 has the fitting key thereof 15, 25 and 35 inserted through the designated key slot of the respective cylinder lock of the lock set.

Each of the lock sets 10, 20 and 30 has a stator 11, 21 and 31 respectively, with a stator groove 19, 29 and 39 slotted over its inner wall, a rotatable member 12, 22 and 32 having a slot forming a side surface having indentations for receiving therein protrusions 13a and 13b, 23a and 234b and 33a and 33b of their respective security elements 13, 23 and 33. Each security element 13, 23 and 33 is pivotally connected to its respective rotatable member 12, 22 and 32 via a hinge and is rotatable about an axis y1, y2 and y3 thereof. Each lock set of 10, 20 and 30 has a spring buffering element 18, 28 and 38 designed to be received by a designated recess 17, 27 and 37 of the security element 13, 23 and 33.

Each key 15, 25 and 35 has an extendible member 16, 26 and 36 and a recess 14, 24 and 34 of a different depth for engaging the fitting keys thereof such that the security elements 13, 23 and 33 will reach the non-obstructing position thereof when their respective fitting keys 15, 25 and 35 are fully inserted in their respective key slots, by rotating about their respective axes y1, y2 and y3 when their fitting keys 15, 25 and 35 are inserted to push out portions of the security elements 13, 23 and 33 that protruded into the grooves 19,29 and 39 before the keys were inserted due to force applied thereover by the buffering element 18, 28 and 38.

The buffering elements 18, 28 and 38 are located offset from the rotation axes y1, y2 and y3 of the security elements 13, 23 and 33, respectively, and on an opposite side of that axis y1, y2 or y3 in respect to the extendible members' 16, 26 and 36 locations so as to also counterpoise thereof. The extendible pin 16, 26 and 36 are extended in response to the length of their corresponding security element's second protrusion 13b, 23b and 33b for engaging therewith by simply being pushed towards the key away from the rotatable member's inner walls by the second protrusion 13b, 23b and 33b.

As mentioned above, the main purpose of the buffering elements 18, 28 and 38 is to maintain the security elements 13, 23 and 33 in their obstructing position when no key is placed in the rotatable members' 12, 22 and 32 key slots.

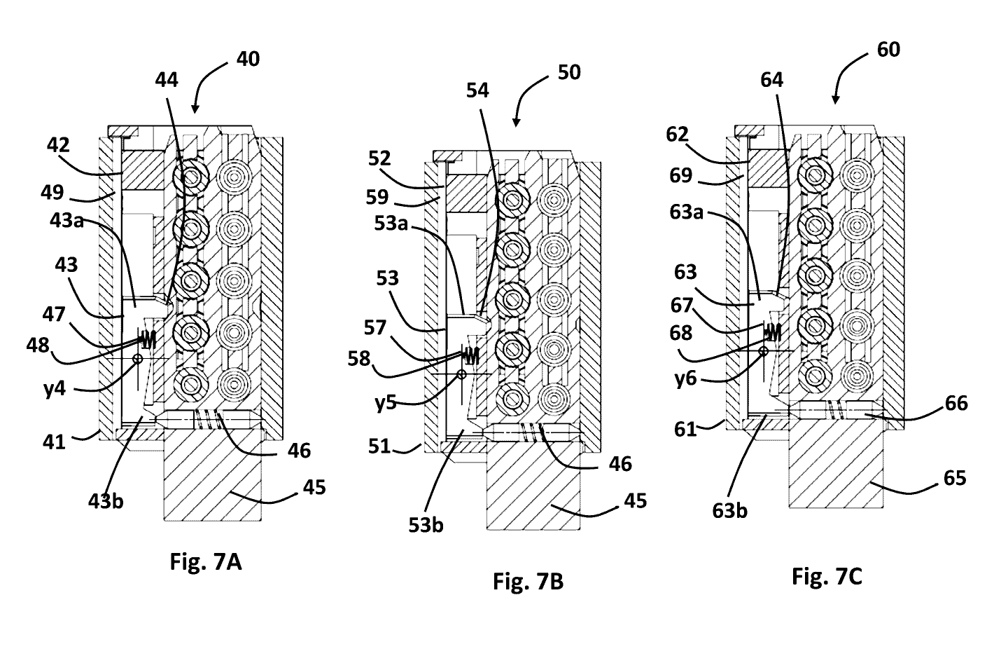

FIGS. 7A-7C show cross sectional views of three different lock sets 40, 50 and 60 having a security element 43, 53 and 63 of a specific second type having the same overall length L2 which is shorter than L1. Each lock set 40, 50 and 60 has the fitting key thereof 45, 55 and 65 inserted through the designated key slot of the respective cylinder lock of the lock set.

Each of the lock sets 40, 50 and 50 has a stator 41, 51 and 61 respectively, having a stator groove 49, 59a and 69 indented in its inner wall, a rotatable member 42, 52 and 62 having a slot forming a side surface having indentations for receiving therein protrusions 43a 53b, 63a and 43b, 53a and 63b of their respective security elements 43, 53 and 63. Each security element 43, 53 and 63 is pivotally connected to its respective rotatable member 42, 52 and 62 via a hinge and is rotatable about an axis y4, y5 and y6 thereof. Each lock set of 40, 50 and 60 has a spring buffering element 48, 58 and 68 designed to be received by a designated recess 47, 57 and 67 of the security element 43, 53 and 63.

The buffering elements 48, 58 and 68 are located offset from the rotation axes y4, y5 and y6 of the security elements 43, 53 and 63, respectively, and on an opposite side of that axis y4, y5 or y6 in respect to the extendible members' 46, 56 and 66 locations so as to counterpoise thereof.

As mentioned above, FIGS. 8A, 8B and 8C show different security elements of the first type having the same overall length L1 and varied protrusions lengths and/or inner indentations sizes and/or locations and FIGS. 9A, 9B and 9C show different security elements of the second type having the same overall length L2, whereas L1>L2. These form a set of six possible different security elements allowing having 1,449,459 combinations of unique lock sets for cylinder locks thereof having five extendible pins locking mechanism.

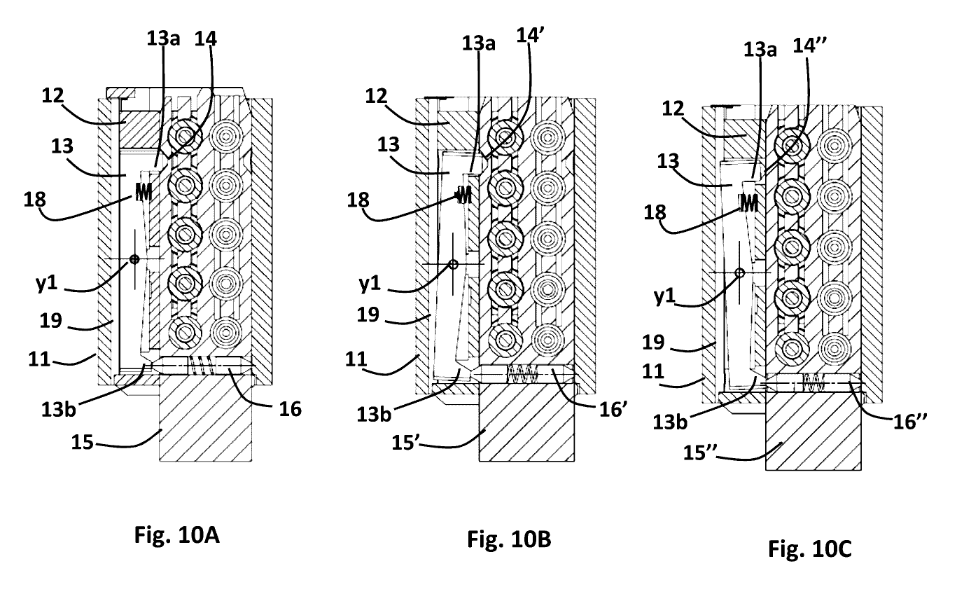

FIGS. 10A-10C show how using unfitting keys such as keys 15′ and 15″ for attempting to rotate the rotatable member 12 of the same lock set 10 will maintain the security element 13 of the lock set in its obstructing position, in which a portion thereof protrudes towards the stator 11 inner wall and inside the stator groove 19.

FIG. 10A shows the lock set 10 with the fitting key 15 inserted thereto. In this case the security element 13 outer side wall is parallel to the rotation axis of the rotational member 12 and does not protrude from its outer wall thereby allowing rotation of the rotatable member 12 inside the stator 11, since the spring of the extendible member 16 applies a force that counterpoise the one applied by the spring 18 of the buffering element of the cylinder lock.

FIG. 10B shows an unfitting key 15′ inserted through the key slot of the cylinder lock rotatable member 12 having a recess 14′ that is too deep, causing the extendible member 16′ of the key to push the first protrusion 13a of the security element 13 further into the too deep recess 14′ thereby causing the portion of the security element 13 to protrude from the outer wall of the rotatable member 12 into the stator groove 19 preventing the rotatable member 12 from rotating in the stator 11.

FIG. 10B shows an unfitting key 15′ inserted through the key slot of the cylinder lock rotatable member 12 having a recess 14′ that is too shallow, causing the extendible member 16′ of the key to push the first protrusion 13a of the security element 13 causing the lower portion of the security element 13 to protrude from the outer wall of the rotatable member 12 into the stator groove 19 preventing the rotatable member 12 from rotating in the stator 11. FIG. 9C shows an unfitting key 15″ inserted through the key slot of the cylinder lock rotatable member 12 having a recess 14″ that is too shallow, causing the extendible member 16″ thereof to be pushed backwards towards the key and thereby causing the upper portion of the security element 13 to protrude from the outer wall of the rotatable member 12 into the stator groove 19 preventing the rotatable member 12 from rotating in the stator 11.

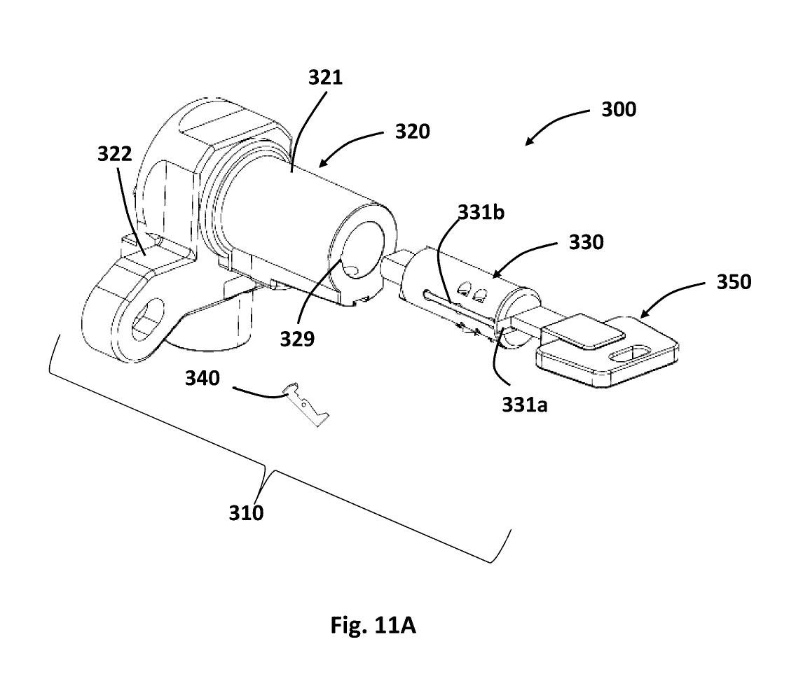

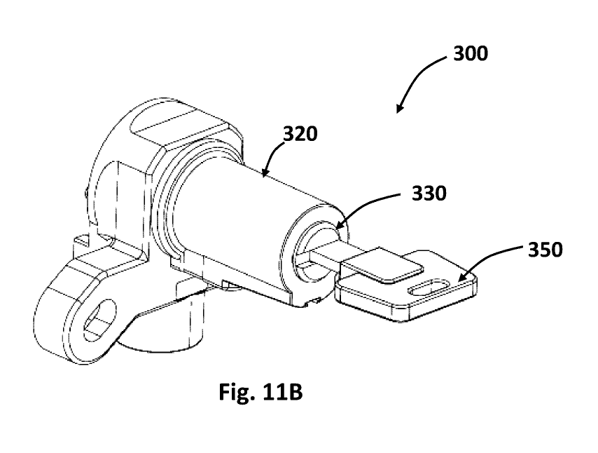

FIGS. 11A and 11B show a lock set 300, according to other embodiments of the invention, having a cylinder lock 310 additional locking mechanism, a stator 320 having a stator body 321 with a stator groove 329 slotted through its inner wall, the body 321 being connectable to a cam 322 and a rotatable member 330 having a key slot extended to a side slot 331 for receiving a security element 340 therein and a designated fitting key 350 additional locking mechanism; a rotatable member 330 with a key slot 331a and a side slot 331b for receiving therein the security element 340.

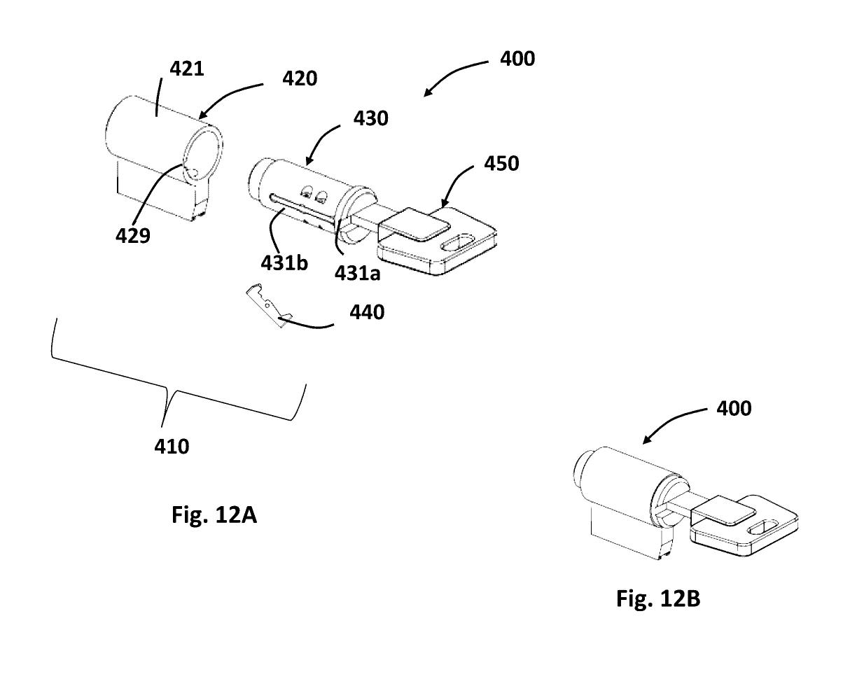

FIGS. 12A and 12B show a lock set 400 having a KIK (key in knob) type cylinder lock 410, according to yet other embodiments of the invention. The cylinder lock 410 includes a stator 420 having a cylindrical stator body 421 with a stator groove 429 slotted over its inner wall, and a rotatable member 430 coaxially inserted in the stator 420. The rotatable member 430 has a designated key slot 431a for receiving therein the elongated portion of the key 450 of the set 400 and a side slot 431b for receiving from a side thereof a security element 440. additional locking mechanism

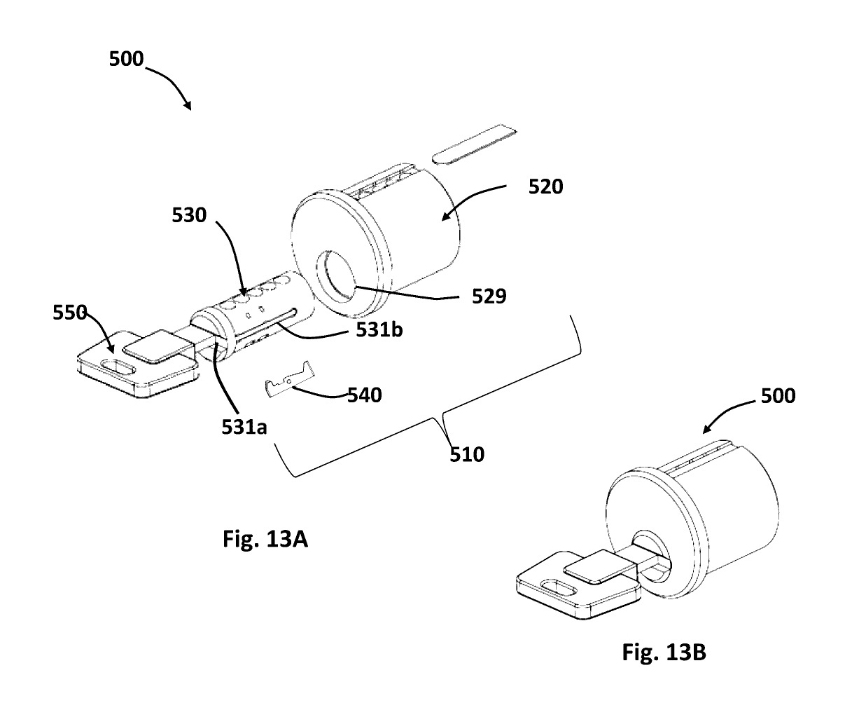

FIGS. 13A and 13B show a lock set 500 including cylinder lock 510, according to other embodiments of the invention. The cylinder lock 510 includes a rotatable member 530 and a cylindrical stator 520 configured for coaxially receiving therein the rotatable member 530. The rotatable member 530 has a designated key slot 531 for receiving therein the elongated portion of the key 550 of the set 500 and a side slot 531 for receiving from a side thereof a security element 540. The stator 520 has a cylindrical body with a stator groove 529 slotted over an inner wall thereof.

As mentioned above any number, shapes and sizes of protrusions can be used for the security elements and any corresponding number shapes and sizes of extendible members and recess can be used for the fitting keys thereof, where the number of protrusions and variations of their shapes and sizes as well as variations of the lengths of the security elements determine the number of possible combinations for unique lock sets combined with the number of possibilities for the additional locking mechanisms.

The structural concepts of the present invention allow using very few groups of mass produced security elements having very few unified designs and corresponding keys' recesses and extendible members to yield a large number of possible unique locking combinations when incorporated with the combinations enabled from the additional locking mechanism.

The method for manufacturing such lock sets involve, in some embodiments, providing generic components of cylinder locks of a single type and design including the same mass produced duplicate stators, rotatable members and the same generic key blanks (before indenting one or more recesses and/optionally before forming the extendible member(s) hole(s) and only manufacture multiple pieces of security elements of singular designs and then forming the recesses at the side(s) of each key in location(s) and depth(s) that correspond additional locking mechanism to the security element size and design for each lock set to specify it.

If the lock sets should have another additional locking mechanism such as the extendible pins based mechanism, coded indentation over the key are also to be formed as well as opening of designated extendible pins into the rotatable member in designated recesses thereof.

The present invention also provides one or more key blanks each having an elongated key member and one or more extendible members such as described above inserted through one or more designated holes in the elongated key member for allowing duplication or formation of a specific unique key for each cylinder lock of each lock set by forming one or more recesses over one or more sides of the elongated key member thereof that fit in size, depth and location to one or more of the protrusions of the security element of the cylinder key. Each recesses will be located such that when the key member is inserted through the key slot of the rotatable member of the cylinder lock, it will receive therein a corresponding security element or portion thereof such that all protrusions that are inserted through the key one or more recesses will allow rotation of the security element to its non-obstructing position.

The present invention further provides a method for adapting a key blank, having one or more extendible members therein, to a specific cylinder lock having the stator, the security element and the rotatable member as described above by forming one or more recesses over at least one side thereof in locations and properties such as shape and/or depths that correspond to length and locations of at least one of the protrusions of the at least one security element in the cylinder lock.

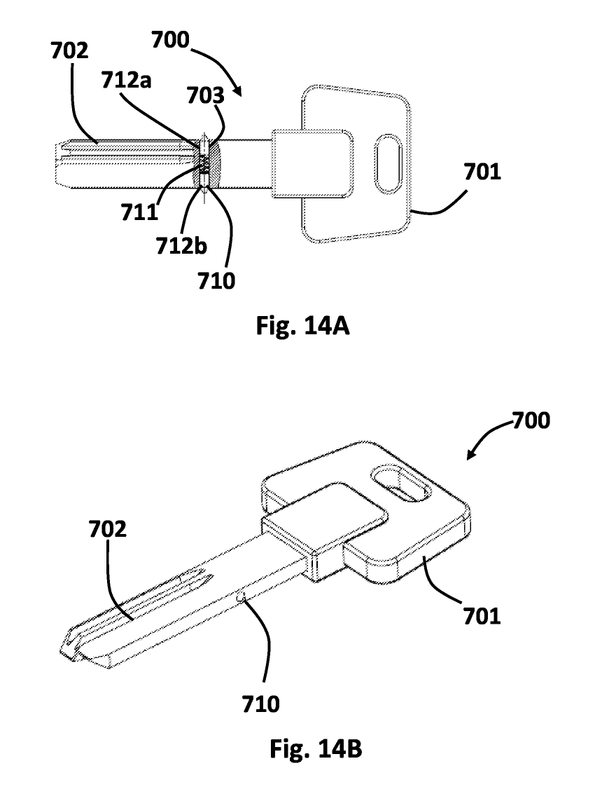

Reference is now made to FIGS. 14A and 14B showing a key blank 700 according to some embodiments of the present invention, having a key head 701 FIGS. 14A and 14B show a key blank of some embodiments of the present invention, having an extendible member inserted through a designated opening over a side thereof for adapting thereof to a specific lock set cylinder lock having a security element with two or more protrusions by forming one or more recesses over the same or another side thereof in locations and properties such as depth and size that correspond to the protrusions of the security element they are to receive therein, an elongated key member 702 and an extendible member 710 inserted through a designated opening 703 over a side of the elongated key member 702 for adapting thereof to a specific lock set cylinder lock. The specific lock includes a security element with two or more protrusions and the adaptation of the key blank to form a fitting key to the specific cylinder lock security element is done by forming one or more recesses over the same or another side thereof in locations and properties such as depth and size that correspond to the protrusions of the security element they are to receive therein

The extendible member 710 includes a spring 711 FIGS. 14A and 14B show a key blank of some embodiments of the present invention, having an extendible member inserted through a designated opening over a side thereof for adapting thereof to a specific lock set cylinder lock having a security element with two or more protrusions by forming one or more recesses over the same or another side thereof in locations and properties such as depth and size that correspond to the protrusions of the security element they are to receive therein and two pins 712a and 712b each engaging or connecting to a different spring edge and can protrude from each side of the opening 703 in the key member 702.

As mentioned above to form a key that fits to a specific cylinder lock e.g. for completing the lock set in the production stage or for duplicating a key for the cylinder lock the individual producing the fitting key such as a locksmith should form one or more recesses, each at a specific location i.e. at a specific distance from the extendible member 710 and from one another that correspond to the distances between the protrusions of the cylinder lock's security element. The one or more recesses forming should be done such that each recess will have properties such as depth, size, shape and the like that will allow their corresponding protrusion to fit into the recess in a manner that will allow rotating the security element to reach the non-obstructing position when the fitting key formed thereby is inserted into a key slot of the cylinder lock rotating its rotatable member inside the stator thereof.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A lock set comprising:
a) a cylinder lock having a stator and a rotatable member configured for being coaxially situated in said stator for rotating therein, said rotatable member having at least one key slot for receiving the key therein and at least one side slot;
b) at least one security element having at least two protrusions, said security element being configured to fit into said side slot of said rotatable member and pivotally connected to said rotatable member; and
c) at least one key with an elongated key member having at least one recess disposed over at least one side thereof and at least one extensible member inserted inside said elongated key member and protruding from at least one side thereof, said extendible member being configured to move along a predefined axis from which it protrudes, said at least one recess is located and configured such as to fit in engagement to at least one of the security element's protrusions such that when said fitting key is inserted through the key slot of the rotatable member the protrusions of said security element engage the at least one extendible member and the at least one recess of said fitting key such that the security element is positioned in a non-obstructing position, in which no portion thereof protrudes from an outer wall of said rotatable member allowing thereby rotation of said rotational member in said stator,
wherein an unfitting key inserted into the key slot will cause the security element to reach or maintain it in a obstructing position, in which said at least a portion of said security element protrudes from the outer wall of the rotatable member engaging the inner wall of the stator thereby preventing the rotatable member from rotating in the stator.

2. The lock set according to claim 1 further comprising a buffering element located and configured such as to engage said security element in said cylinder lock such as to maintain it in the obstructing position when no key is inserted through said key slot, such that a fitting key will rotate said security element about its axis for bringing it to the non-obstructing position.

3. The lock set according to claim 2, wherein said buffering element comprises at least one spring fitted into a designated recess at said security element which it engages.

4. The lock set according to wherein said buffering element is located offset from the rotational axis of said security member opposite to the side in which said at least one extendible member of the key is to be positioned when the key is inserted into the cylinder lock.

5. The lock set according to claim 1, wherein said stator comprises a cylindrical body having at least one stator groove slotted over its inner wall located generally opposite and in parallel to the side slot of the rotatable member, wherein in the obstructing position, at least a portion of at least one said security element of said lock set protrudes from the outer wall of said rotatable member and is inserted thereby into said groove.

6. The lock set according to claim 1, wherein a side wall of the side slot of the rotatable member in which the security element is seated has indentations fitted in shape and size for receiving therein the protrusions of the security element.

7. The lock set according to claim 1 further comprising an additional locking mechanism comprises a set of pins or extendible pins located in said rotatable member of the cylinder lock for locking and unlocking upon engagement with respective indentations over at least one side of each said fitting key.

8. The lock set according to claim 1, wherein said extendible member in said fitting key comprises two pins engaging a spring located therebetween.

9. The lock set according to claim 1, wherein said lock set is designed as a door lock or as a vehicle starter or vehicle door lock.

10. The lock set according to claim 1, wherein said stator of said cylinder lock comprises a rotatable cam having at least one tenons thereover.

11. The lock set according to claim 1, wherein said rotatable member comprises at least one hole for threading a hinge therethrough for pivotally connecting said security element to an inner wall of said rotatable member formed by the side slot thereof.

12. The lock set according to claim 11, wherein said rotatable member comprises multiple holes for determining the location of the hinge and thereby the location of the security element in said side slot according to the security element size being used.

13. The lock set according to claim 1, wherein said cylinder lock further comprises at least one buffering element and said security element comprises at least one indentation or protrusion located such as to engage said at least one buffering element.

14. The lock set according to claim 1 comprising multiple security elements each fitting at least one recess located at different sides of said at least one fitting key.

15. A method for producing lock sets, said method comprising:
a) providing multiple stators for cylinder locks of a specific cylinder lock design all being substantially identical in size and shape;
b) providing multiple identical rotatable members for the cylinder locks design configured to coaxially fit to said stators such as to rotate therein about a rotation axis, each rotatable member having a key slot therein for receiving a key and at least one side slot;
c) providing multiple blank keys each having an elongated key member;
d) producing multiple security elements each group thereof having a different design each having at least two protrusions;
e) providing multiple extendible members each being configured for moving along an axis thereof; and
f) forming a unique lock set by:
selecting a single rotatable member and stator;
selecting at least one specific security element and at least one key blank for forming at least one fitting key of the specific lock set therefrom;
pivotally connecting each of the selected at least one security element to the rotatable member via the side slot thereof
inserting at least one extendible member to its at least one designated opening in each key blank selected for the lock set;
forming at least one recess and at least one hole over at least one side of each key member of each selected key blank at predefined possible locations over each key member for each specific lock set to be produced according to the design of its corresponding selected at least one security element it is to fit; and
inserting at least one extendible member into the at least one opening in each key member of each selected key blank for specifying the key blank turning thereof into a fitting key to the specific key set,
wherein each recess formed in each key of each particular lock set is located and configured such as to fit in engagement at least one of the security element's protrusions such that when a fitting key is inserted through the key slot of the rotatable member the protrusions of the security element engage the at least one extendible member and the at least one recess of the inserted fitting key such that the security element is positioned in a non-obstructing position, in which no portion thereof protrudes from an outer wall of the rotatable member allowing thereby rotation of the rotational member in the stator of the lock set, and
wherein when an unfitting key is inserted into the key slot the security element will reach or maintain an obstructing position, in which the at least a portion of the security element protrudes from the outer wall of the rotatable member engaging the inner wall of the stator thereby preventing the rotatable member from rotating in the stator.

16. The method according to claim 14, wherein each stator has a cylindrical body having an opening for receiving a rotatable member therein and at least one stator groove slotted over its inner wall located opposite and in parallel to the side slot of the rotatable member when the rotatable member is inserted therein, said groove is configured for receiving therein a portion of said security element to form the obstructing position.

17. The method according to claim 14, further comprising forming multiple holes over each security element for allowing determining a location of a hinge and thereby the location of the security element in said side slot according to the security element size being used for the particular lock set.

18. The method according to claim 14 further comprising adding an additional locking mechanism to the cylinder lock to increase the number of possible combinations of unique lock sets.

19. The method according to claim 18, wherein adding said additional locking mechanism involves adding multiple extendible pins penetrated through openings in each said rotatable member and indenting at least one side of each key with indentations that correspond to the locations and lengths of the extendible pins of the particular cylinder lock.

20. The method according to claim 14 further comprising fixing at least one buffering element in said cylinder lock located and configured such as to maintain the security element in the rotatable member in ab obstructing position until a counterpoised force is applied thereto by a fitting key inserted through the key slot of the particular rotatable member.

21. The method according to claim 14 further comprising slotting at least one groove over an inner wall of each stator for receiving therein the portion of the security element when the security element protrudes from the outer wall of the rotatable member, wherein the location and design of each groove fits the location and design of the security element when located in said rotatable member.

22. The method according to claim 21, wherein said buffering element comprises a spring.

23. A key blank for forming therewith a fitting key to a cylinder lock, said key blank comprising:
a) an elongated key member having at least one opening over at least one side thereof; and
b) at least one extendible member each inserted in each of said at least one opening in said elongated key member,
wherein at least one side of said extendible member protrudes from said opening and is extendible along an axis of its protrusion in response applied thereover,
wherein said key blank is configured for producing therewith a key for a specific cylinder lock by forming at least one recess over at least one side thereof, each recesses is formed for receiving therein a protrusion of a security element of said cylinder lock, such that the location and depth of each recesses is adapted to the location and the length of the protrusion it is to receive therein,
wherein the each extendible member of the fitting key engages a respective protrusion of the security element and each recess of the fitting key receives therein another protrusion of the security element fitting thereto such as to have the security element positioned in a non-obstructing position, when the key is inserted in the cylinder lock, in which a rotatable member of the cylinder lock can freely rotate in a stator thereof by having the security element reach a position in which it does not protrude from outer wall of the rotatable member.

24. A method for forming a fitting key using a key blank, for fitting to a specific cylinder lock, said method comprising:
a) providing a specific cylinder lock having a stator, a rotatable member configured for rotating in said stator, said rotatable member having a key slot and at least one side slot, and a security element having protrusions pivotally connected in said rotatable member via its side slot;
b) providing a blank key having an elongated key member with at least one opening over at least one side thereof and at least one extendible member each inserted in each of said at least one opening in said elongated key member;
c) forming at least one recess over at least one side of said elongated key member of the key blank for forming a fitting key to the specific cylinder lock,
wherein at least one side of each said extendible member protrudes from said opening and is extendible along an axis of its protrusion in response applied thereover,
wherein each recesses is formed for receiving therein a protrusion of the security element of said specific cylinder lock, such that the location and depth of each recesses is adapted to the location and the length of the protrusion it is to receive therein,
wherein, when the fitting key is inserted through the key slot, each extendible member of the fitting key engages a respective protrusion of the security element and each recess of the fitting key receives therein another protrusion of the security element fitting thereto such as to have the security element positioned in a non-obstructing position, in which the rotatable member can freely rotate in the stator by having the security element reach a position in which it does not protrude from outer wall of the rotatable member.
